(19) United States
(12) Patent Application Publication
(10) Pub. No.: US 2008/0001075 A1
(43) Pub. Date: Jan. 3, 2008

(54) MEMORY STAGE FOR A PROBE STORAGE DEVICE

(75) Inventors: Peter David Ascanio, Fremont, CA (US); Nickolai Belov, Los Gatos, CA (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 11/553,435

(22) Filed: Oct. 26, 2006

Related U.S. Application Data
(60) Provisional application No. 60/813,975, filed on Jun. 15, 2006.

(51) Int. Cl. H01J 40/14

(52) U.S. Cl. 250/234; 977/849

(57) ABSTRACT

An embodiment of a probe storage device in accordance with the present invention can include a media frame, a media stage including a media, a suspension arrangement moveably connecting the media stage with the media frame, the suspension arrangement including a suspension, and a tip stage having a tip extending therefrom, the tip stage being arranged so that the media is accessible to the tip. The suspension can comprise a foot fixedly connected with the media frame, a knee, a first flexure connected between the foot and the knee so that the knee is moveable relative to the foot, and a second flexure connected between the media stage and the knee so that the media stage is moveable relative to the knee.

### CLAIM OF PRIORITY

This application claims priority to the following U.S. Provisional Application:

U.S. Provisional Patent Application No. 60/813,975 entitled MEMORY STAGE FOR A PROBE STORAGE DEVICE, by Peter David Ascanio et al., filed Jun. 15, 2006, Attorney Docket No. NANO-1043US0.

### CROSS-REFERENCE TO RELATED PATENT APPLICATIONS

This application incorporates by reference all of the following co-pending applications and the following issued patents:

U.S. Patent Application No. 60/813,817 entitled “Bonded Chip Assembly with a Micro-Mover for Microelectromechanical Systems,” by Nickolai Belov, filed Jun. 15, 2006, Attorney Docket No. NANO-01041US0;

U.S. patent application Ser. No. 11/177,550, entitled “Media for Writing Highly Resolved Domains,” by Yevgeny Vasilievich Anoikin, filed Jul. 8, 2005, Attorney Docket No. NANO-01032US1;

U.S. patent application Ser. No. 11/177,639, entitled “Patterned Media for a High Density Data Storage Device,” by Zhaohui Fan et al., filed Jul. 8, 2005, Attorney Docket No. NANO-01033US0;

U.S. patent application Ser. No. 11/177,062, entitled “Method for Forming Patterned Media for a High Density Data Storage Device,” by Zhaohui Fan et al., filed Jul. 8, 2005, Attorney Docket No. NANO-01033US1;

U.S. patent application Ser. No. 11/177,599, entitled “High Density Data Storage Devices with Read/Write Probes with Hollow or Reinforced Tips,” by Nickolai Belov, filed Jul. 8, 2005, Attorney Docket No. NANO-01034US0;

U.S. patent application Ser. No. 11/177,731, entitled “Methods for Forming High Density Data Storage Devices with Read/Write Probes with Hollow or Reinforced Tips,” by Nickolai Belov, filed Jul. 8, 2005, Attorney Docket No. NANO-01034US1;

U.S. patent application Ser. No. 11/177,642, entitled “High Density Data Storage Devices with Polarity-Dependent Memory Switching Media,” by Donald E. Adams, et al., filed Jul. 8, 2005, Attorney Docket No. NANO-01035US0;

U.S. patent application Ser. No. 11/178,060, entitled “Methods for Writing and Reading in a Polarity-Dependent Memory Switching Media,” by Donald E. Adams, et al., filed Jul. 8, 2005, Attorney Docket No. NANO-01035US1;

U.S. patent application Ser. No. 11/178,061, entitled “High Density Data Storage Devices with a Lubricant Layer Comprised of a Field of Polymer Chains,” by Yevgeny Vasilievich Anoikin et al., filed Jul. 8, 2005, Attorney Docket No. NANO-01036US0;

U.S. patent application Ser. No. 11/004,153, entitled “Methods for Writing and Reading Highly Resolved Domains for High Density Data Storage,” by Thomas F. Rust et al., filed Dec. 3, 2004, Attorney Docket No. NANO-01024US1;

U.S. patent application Ser. No. 11/003,953, entitled “Systems for Writing and Reading Highly Resolved Domains for High Density Data Storage,” by Thomas F. Rust, et al., filed Dec. 3, 2004, Attorney Docket No. NANO-01024US2;

U.S. patent application Ser. No. 11/004,709, entitled “Methods for Erasing Bit Cells in a High Density Data Storage Device,” by Thomas F. Rust, et al., filed Dec. 3, 2004, Attorney Docket No. NANO-01031 US0;

U.S. patent application Ser. No. 11/003,541, entitled “High Density Data Storage Device Having Erasable Bit Cells,” by Thomas F. Rust et al., filed Dec. 3, 2004, Attorney Docket No. NANO-01031US1;

U.S. patent application Ser. No. 11/003,955, entitled “Methods for Erasing Bit Cells in a High Density Data Storage Device,” by Thomas F. Rust et al., filed Dec. 3, 2004, Attorney Docket No. NANO-01031US2;

U.S. patent application Ser. No. 10/684,661, entitled “Atomic Probes and Media for High Density Data Storage,” filed by Thomas F. Rust, filed Oct. 14, 2003, Attorney Docket No. NANO-01014US1;

U.S. Patent Application No. 11,321,136, entitled “Atomic Probes and Media for High Density Data Storage,” by Thomas F. Rust, filed Dec. 29, 2005, Attorney Docket No. NANO-01014US2;

U.S. patent application Ser. No. 10/684,760, entitled “Fault Tolerant Micro-Electro Mechanical Actuators,” by Thomas F. Rust, filed Oct. 14, 2003, Attorney Docket No. NANO-01015US1;

U.S. patent application Ser. No. 09/465,592, entitled “Molecular Memory Medium and Molecular Memory Integrated Circuit,” by Joannne P. Culver et al., filed Dec. 17, 1999, Attorney Docket No. NANO-01000US0;

U.S. Pat. No. 5,453,970, entitled “Molecular Memory Medium and Molecular Memory Disk Drive for Storing Information Using a Tunnelling Probe,” issued Sep. 26, 1995 to Thomas F. Rust, et al.;

U.S. Pat. No. 6,982,898, entitled “Molecular Memory Integrated Circuit Utilizing Non-Vibrating Cantilevers,” Attorney Docket No. NANO-0101US1, issued Jan. 3, 2006 to Thomas F. Rust, et al.;

U.S. Pat. No. 6,985,377, entitled “Phase Change Media for High Density Data Storage,” Attorney Docket No. NANO-01019US1, issued Jan. 10, 2006 to Thomas F. Rust, et al.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates to high density data storage using molecular memory integrated circuits.

### BACKGROUND

Software developers continue to develop steadily more data intensive products, such as ever-more sophisticated, and graphic intensive applications and operating systems (OS). Each generation of application or OS always seems to earn the derisive label in computing circles of being “a memory hog.” Higher capacity data storage, both volatile and non-volatile, has been in persistent demand for storing code for such applications. Add to this need for capacity, the confluence of personal computing and consumer electronics in the form of personal MP3 players, such as the iPod, personal digital assistants (PDAs), sophisticated mobile phones, and laptop computers, which has placed a premium on compactness and reliability.

Nearly every personal computer and server in use today contains one or more hard disk drives for permanently storing frequently accessed data. Every mainframe and supercomputer is connected to hundreds of hard disk drives. Consumer electronic goods ranging from camcorders to TiVo® use hard disk drives. While hard disk drives store large amounts of data, they consume a great deal of power, require long access times, and require “spin-up” time on power-up. FLASH memory is a more readily accessible form of data storage and a solid-state solution to the lag time and high power consumption problems inherent in hard disk drives. Like hard disk drives, FLASH memory can store data in a non-volatile fashion, but the cost per megabyte is dramatically higher than the cost per megabyte of an equivalent amount of space on a hard disk drive, and is therefore sparingly used.

Phase change media are used in the data storage industry as an alternative to traditional recording devices such as magnetic recorders (tape recorders and hard disk drives) and solid state transistors (EEPROM and FLASH). CD-RW data storage discs and recording drives use phase change technology to enable write-erase capability on a compact disc-style media format. CD-RWs take advantage of changes in optical properties (e.g., reflectivity) when phase change material is heated to induce a phase change from a crystalline state to an amorphous state. A “bit” is read when the phase change material subsequently passes under a laser, the reflection of which is dependent on the optical properties of the material. Unfortunately, current technology is limited by the wavelength of the laser, and does not enable the very high densities required for use in today's high capacity portable electronics and tomorrow's next generation technology such as systems-on-a-chip and micro-electric mechanical systems (MEMS). Consequently, there is a need for solutions which permit higher density data storage.

### BRIEF DESCRIPTION OF THE DRAWINGS

Further details of the present invention are explained with the help of the attached drawings in which:

FIG. 1 is an exemplary mechanism for positioning two stages relative to one another in accordance with the prior art.

FIG. 2 is an exemplary mechanism for positioning two stages relative to one another in accordance with the prior art.

FIG. 3 is a plan view of an embodiment of a mechanism for use in positioning a media device relative to a contact probe tip stage in accordance with the present invention.

FIG. 4A is a plan view of a magnet structure for use with the embodiment of FIG. 3.

FIG. 4B is a cross-sectional side view of the magnet structure of FIG. 4A.

FIG. 5 is an exploded view of an embodiment of an assembly for use in probe storage devices in accordance with the present invention.

FIG. 6A is a plan view of the embodiment of FIG. 3 having a suspension arrangement further including a mass dampener.

FIG. 6B is a plan view of an alternative embodiment of a suspension arrangement of a mechanism for use in positioning a media stage relative to a contact probe tip stage in accordance with the present invention.

FIG. 6C is a plan view of a still further embodiment of a suspension arrangement of a mechanism for use in positioning a media stage relative to a contact probe tip stage in accordance with the present invention.

FIG. 6D is a plan view of a still further embodiment of a suspension arrangement of a mechanism for use in positioning a media stage relative to a contact probe tip stage in accordance with the present invention.

FIG. 6E is a plan view of a still further embodiment of a suspension arrangement of a mechanism for use in positioning a media stage relative to a contact probe tip stage in accordance with the present invention.

FIG. 6F is a plan view of the embodiment of FIG. 6E having a suspension arrangement further including flexures to increase rotational stiffness.

### DETAILED DESCRIPTION

Probe storage devices enabling higher density data storage relative to current technology can include cantilevers with contact probe tips as components. Such probe storage devices typically use two parallel plates. A first plate (also referred to herein as a contact probe tip stage) includes cantilevers with contact probe tips extending therefrom for use as read-write heads and a second, complementary plate (also referred to herein as a media stage) includes a media device for storing data. At least one of the plates can be moved with respect to the other plate in a lateral X-Y plane while maintaining satisfactory control of the Z-spacing between the plates. Motion of the plates with respect to each other allows scanning of the media device by the contact probe tips and data transfer between the contact probe tips and the media device.

In some probe storage devices, for example utilizing phase change materials in a stack of the media device, both mechanical and electrical contact between the contact probe tips and the media device enables data transfer. In order to write data to the media device, current is passed through the contact probe tips and the phase change material to generate heat sufficient to cause a phase-change in some portion of the phase change material (said portion also referred to herein as a memory cell). Electrical resistance of the memory media can vary depending on the parameters of the write pulse, and therefore can represent data. Reading data from the memory media requires a circuit with an output sensitive to the resistance of the memory cell. An example of one such circuit is a resistive divider. Both mechanical and electrical contact between the contact probe tip and the media device can also enable data transfer where some other media device is used, for example memory media employing polarity-dependent memory.

Probe storage devices in accordance with the present invention can employ an array of contact probe tips to read data from, or write data to a media device. The media device can include a continuous recording media, or alternatively the media device can be patterned to define discrete memory cells having dimensions as small as approximately 40 nm or less. A contact probe tip can access a portion of the surface of the media device, the portion being referred to herein as a tip scan area. The tip scan area can vary significantly and can depend on contact tip probe layout and/or media device layout. For purposes of example, the tip scan area can approximate a 100 μm×100 μm (10,000 μm²) portion of the surface media device. To enable the contact probe tip to access substantially the full range of the tip scan area, the contact probe tip stage can move within the tip scan area and the media stage can be fixed in position. Alternatively, the contact probe tip stage can be fixed, and the media stage can move within the range of the tip scan area. The moving stage moves in both lateral (X) and transverse (Y) motion (also referred to herein as Cartesian plane motion) to traverse the tip scan area. Alternatively, both the contact probe tip stage and the media stage can move in a single direction, with one stage moving along the X-axis and the other stage moving along the Y-axis.

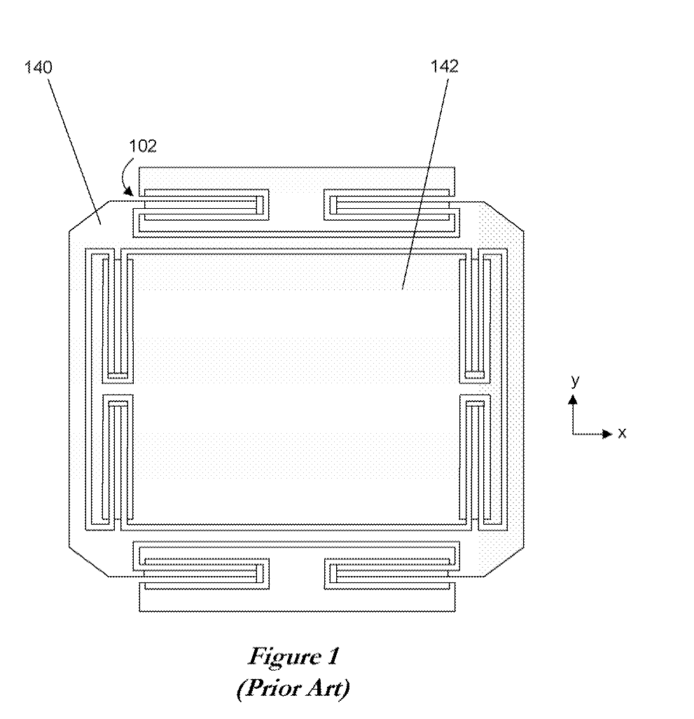

FIG. 1 illustrates an example of a mechanism in accordance with the prior art for positioning a contact probe tip stage and a media stage relative to one another. Such mechanisms are described in U.S. Pat. No. 5,986,381 to Hoen et al. The exemplary mechanism of FIG. 1 consists of two movable stages, an outer stage 140 that is movable along an axis (e.g. a lateral axis) and an inner stage 142 that is nested within the outer stage 140 and movable along a perpendicular axis (e.g. a transverse axis). Movement of the inner and outer stage is induced by electrostatic actuation. The electrostatic actuators 102 comprise flexures positioned along the peripheries of the stages. The flexures 102 support the mass of the stages. The mechanism is susceptible to shock events because the flexures are not arranged in a mutually perpendicular fashion without a significant intermediate mass placed between the flexures. Further, the nested arrangement of the electrostatic actuators is not space efficient, requiring dedication of a significant portion of a die which otherwise may be used for expanding stage size.

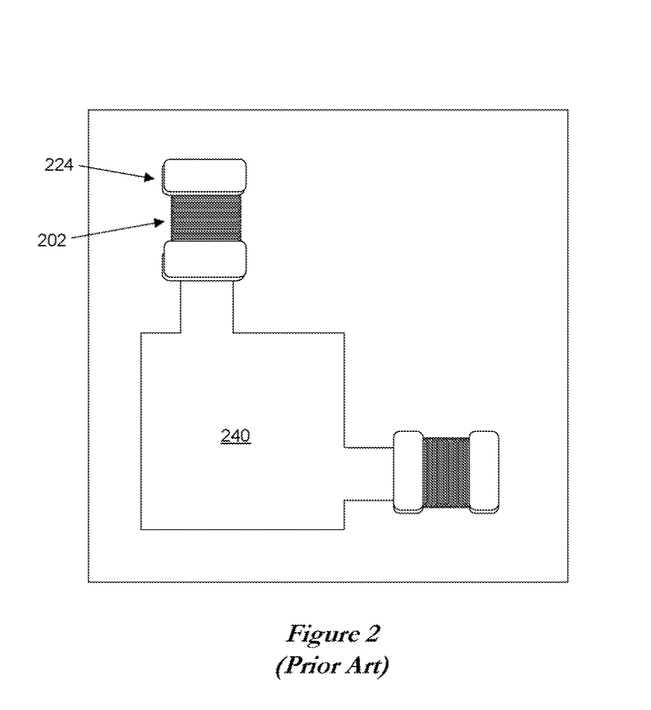

FIG. 2 illustrates another mechanism in accordance with the prior art for positioning a contact probe tip stage and a media stage relative to one another. Such a mechanism has been proposed for use with IBM's “Millipede” probe storage system. The mechanism consists of a scan table 240 on which a stage is disposed. Movement of the scan table 240 is induced by electromagnetic actuation. The electromagnetic actuators comprise a coil 202 connected with the scan table 240 and disposed within a magnetic field created by two magnets 224. The electromagnetic actuators are provided for each axis of movement and are positioned co-planar and outside of the scan table 240. As can be seen the electromagnetic actuators require dedication of a significant portion of a die which otherwise may be used for expanding stage size. As shown, the effective media utilization for data storage is less than 20%. Consequently, the total capacity per device is limited.

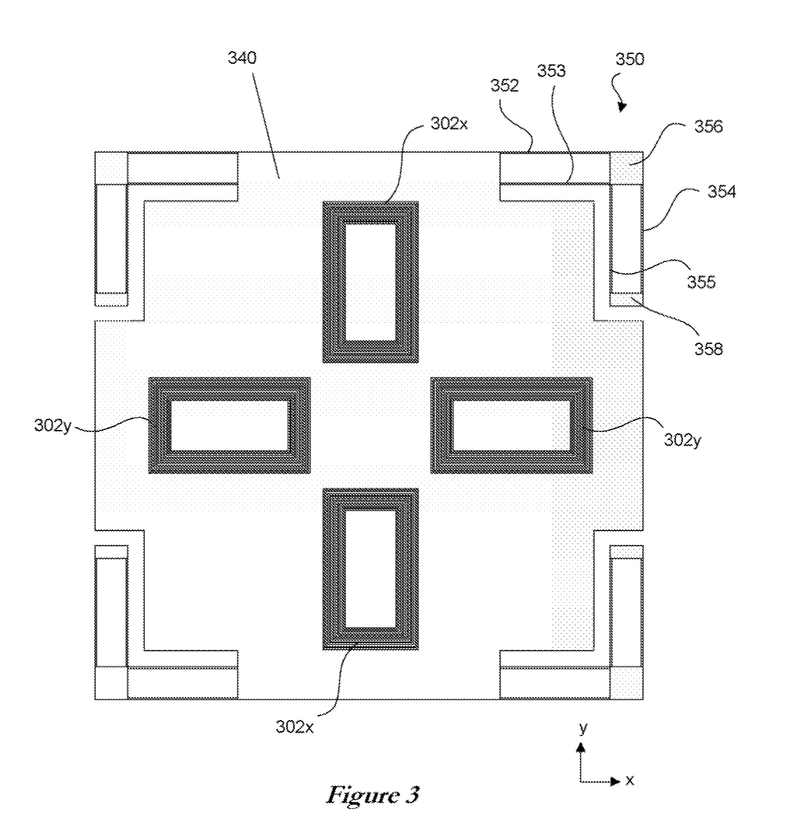

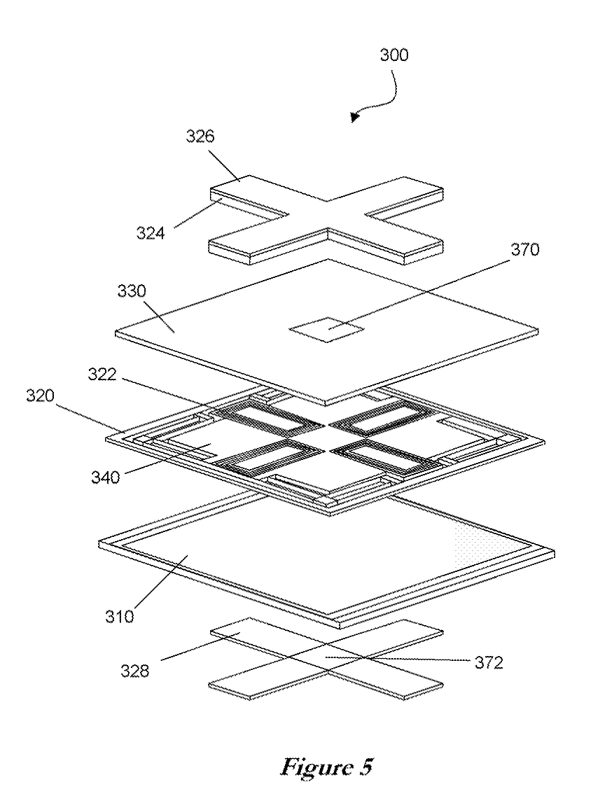

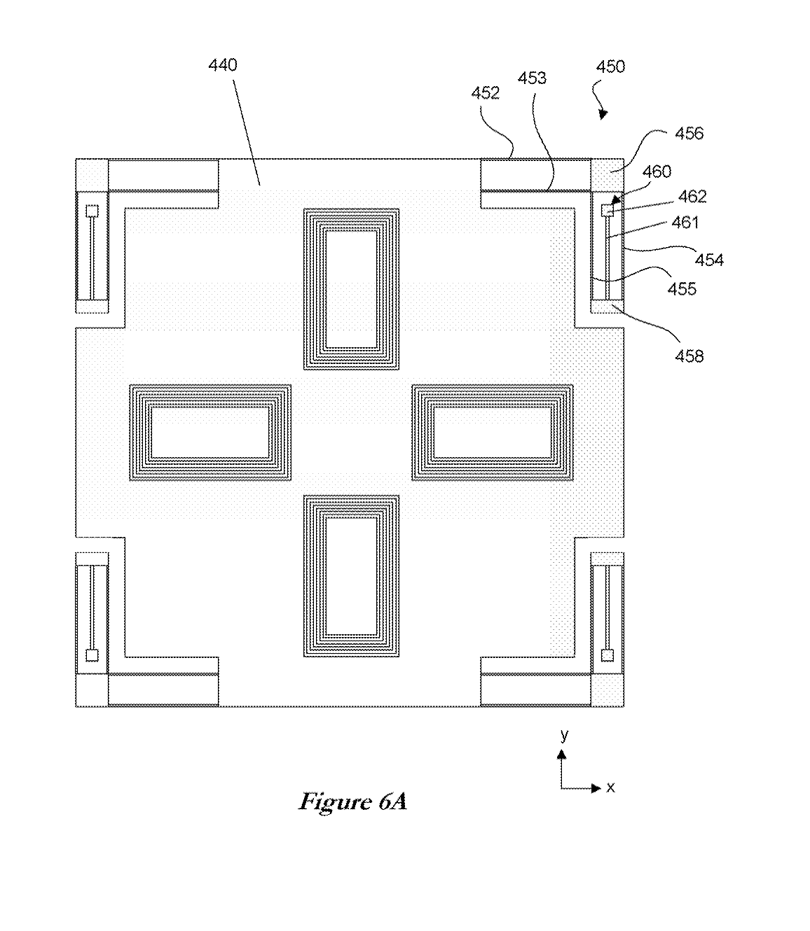

Referring to FIGS. 3 and 5, an embodiment of a system in accordance with the present invention can employ a media stage having operatively connected coils placed in a magnetic field such that motion of the media stage in a Cartesian plane can be achieved when current is applied to the coils. The corresponding contact probe tip stage can be fixed in position. The media stage can be urged in a Cartesian plane by taking advantage of Lorentz forces generated from current flowing in a planar coil when a magnetic field perpendicular to the Cartesian plane is applied across the coil current path. The coils can be arranged in a cross configuration (as shown particularly in FIG. 3), and can be formed such that the media device is disposed between the coils and the contact probe tip stage (e.g. fixedly connected with a back of the media stage, wherein the back is a surface of the media stage opposite a surface contactable by the contact probe tip stage). In a preferred embodiment, the coils can be arranged symmetrically about a center of the media stage, with one pair of coils 302x generating force for lateral (X) motion and the other pair of coils 302y generating force for transverse (Y) motion. Utilization of the surface of the media stage for data storage need not be affected by the coil layout because the coils can be positioned so that the media device for storing data is disposed between the coils and the contact probe tip stage, rather than co-planar with the coils. In other embodiments the coils can be formed co-planar with the surface of media stage. In such embodiments, a portion of the surface of the media stage will be dedicated to the coils, reducing utilization for data storage.

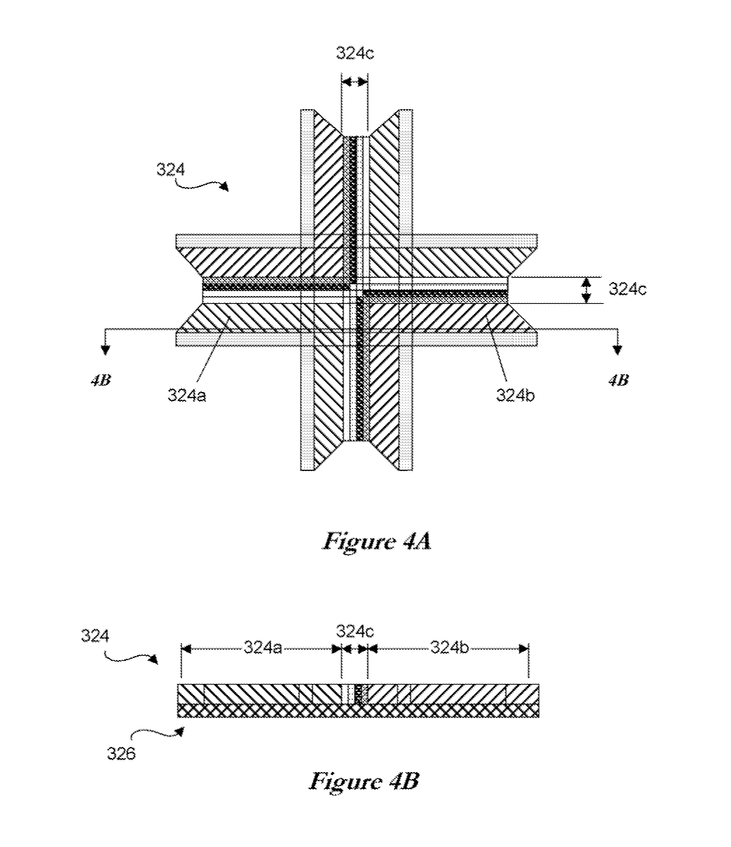

A magnetic field is generated outside of the media stage from a permanent magnet that maps the cross configuration of the coils. As shown in FIGS. 4B and 5, the permanent magnet can be fixedly connected with a rigid structure such as a steel plate that generally maps the permanent magnet to form a magnet structure. A second steel plate generally mapping the permanent magnet can be arranged so that the contact probe tip stage, media stage, and coils are disposed between the magnet structure and the second steel plate. The magnetic flux is contained within the gap between the magnet structure and the second steel plate. In alternative embodiments, a pair of magnets can be employed such that the stages and coils are disposed between dual magnets, thereby increasing the flux density in the gap between the magnets. The force generated from the coil is proportional to the flux density, thus the required current and power to move the media stage can be reduced at the expense of a larger package thickness. There is a possibility that a write current applied to one or more contact probe tips could disturb the media stage due to undesirable Lorentz force. However, for probe storage devices having media devices comprising phase change material, polarity dependent material, or other material requiring similar or smaller write currents to induce changes in material properties, media stage movement due to write currents is sufficiently small as to be within track following tolerance. In some embodiments, it can be desired that electrical trace lay-out be configured to generally negate the current applied to the contact probe tip, thereby minifying the affect.

FIGS. 4A and 4B illustrate a preferred embodiment of a magnet north-south arrangement in a single magnet system for use in probe storage devices in accordance with the present invention. As can be seen, a portion 324a of the magnet 324 can have a north orientation, while a substantially symmetrical portion 324b of the magnet 324 can have a south orientation. Disposed between the north oriented portion 324a and the south oriented portion 324b is a transition zone 324c comprising gradual changes in magnet orientation from north to south and south to north. In other embodiments, the magnet 324 need not have a north-south arrangement as shown in FIG. 4A, but must merely be magnetized such that a desired magnetic flux density be achieved in the gap between the magnet structure and the second steel plate 328. Thus, in other embodiments, some other north-south arrangement in a magnet can be employed.

FIG. 5 shows an exploded view of an embodiment of a stage stack 300 for use in a probe storage device in accordance with the present invention. The stage stack 300 includes a first steel plate 326 bonded to a permanent magnet 324 to form a magnet structure. The magnet structure is bonded to a silicon cap 330. A second steel plate 328 is bonded to a back surface of a contact tip stage 310 (i.e. a surface of the stage opposite of a surface from which cantilevers extend). A media stage 340 is disposed between the contact tip stage 310 and the silicon cap 330. As described below, the media stage 340 can comprise a silicon on insulator (SOI) structure. A media frame 320 with which the media stage 340 is connected is bonded to the contact probe tip stage 310 by way of a bond ring. The bond ring can comprise, in an embodiment, an indium solder ring of some small, substantially uniform thickness disposed along the periphery of one or both of the media frame 320 and the contact probe tip stage 310. The media frame 320 and the contact probe tip stage 310 are fixed in position relative to one another by the bond; however, the media stage 340 can move relative to the media frame 320 and the contact probe tip stage 310 by way of flexures connecting the media frame 320 with the media stage 340.

Four coils can be formed on the back surface of the media stage 340 (i.e. a surface of the media stage opposite of a surface contactable by contact probe tips), or otherwise disposed on the back surface of the media stage 340. The coils can comprise a conductive material such as copper formed to have multiple windings. The resistance of the coil can be minimized by increasing a height (relative to the width) of the coil and increasing the number of windings of the coil. However, increasing the coil height can result in increased bending forces applied to the media stage over the operating temperature range of the probe storage device. Therefore, the electrical characteristics of the coil should be balanced against the bending characteristics produced by the coil over an operating temperature range. In a preferred embodiment, the coils can have a height of a magnitude approximating ten microns.

Preferably the coils can comprise an equal number of windings having approximately the same trace cross-section and pitch, though in other embodiments the cross-section and pitch can vary, so long as a desired relative movement between the media stage and the contact probe tip stage can be achieved with a desired control. The gap between a surface of the media device of the media stage 340 and the contact probe tip stage 310 is hermetically sealed when the silicon cap 330 is bonded to the media frame 320 so that the media stage 340 is disposed between the silicon cap 330 and the contact tip probe stage 310. Preferably the media frame 320 and/or the bond ring can have an approximately uniform height so that a sufficient gap is formed between the media stage 340 and the contact probe tip stage 310 and further so that a sufficient gap is formed between the coils and the silicon cap 330. Further, a lubricant can be formed on one or both of the silicon cap 330 and the coils and/or media stage 340 so that a restrictive frictional force between the silicon cap 330 and the media stage 340 is sufficiently reduced. When the stage stack 300 is assembled, the permanent magnet 324 can generally be aligned with the coils 302 and the second steel plate 328. Although rigid structures of the stage stack 300 have been described as “steel” plates, such plates need not necessarily be formed from steel. In other embodiments, some other metal can be employed.

Referring again to FIG. 3, a preferred embodiment of a suspension arrangement for a media stage in accordance with the present invention is shown. The suspension arrangement comprises multiple “L-shape” suspensions of mutually perpendicular flexures. As shown, an “L-shape” suspension comprises a first pair of flexures 352,353 extending from the media stage 340 to a knee 356 of the suspension 350. A second pair of flexures 354,355 extends from the knee 356 perpendicular to the first pair of flexures 352,353 to a foot 358 of the suspension 350. The foot 358 can be fixedly connected with a media frame 320, as shown in FIG. 5. The flexures 352-355 are arranged to provide relatively isolated X motion and Y motion. For example, if the stage is moved with the two coils aligned along the y-axis, media stage movement produces bending in the flexures connected between the knee and the foot (i.e. in the portion of the L-beam that is parallel to the longest length of the coil). The length of the flexures can be adjusted, shortening the length of the flexures to permit higher media utilization, and increasing the length of the flexures to reduce the power needed to generate motion. A balance can be struck between maximizing the media and minimizing the power.

The suspension 350 can be built by patterning and etching the media stage 340 using a deep RIE etcher. In a preferred embodiment, the suspension 350 can include flexures having height to width aspect rations of 10:1. An example of a flexures can be one having a width of 13.8 um and thickness (corresponding to a thickness of the media stage) of 136 micron. Prior art flexures for use in electrostatic actuators and other movement devices typically include aspect rations of 40:1. A smaller aspect ratio can reduce the tolerance variation during manufacturing, reducing a variation in suspension stiffness and dynamic performance.

The suspension arrangement provides very high shock tolerance. Further, the mutually perpendicular flexures allow substantially isolated motion within the Cartesian plane while reducing cross-coupling. The rotational stiffness of the media stage 340 can be adjusted by changing the spacing between flexure pairs. Narrow flexure spacing produces a lower rotational stiffness while wide flexure spacing produces higher rotational stiffness. The suspension arrangement of FIG. 3 consumes a small percentage of the media stage 340, relative to suspensions of the prior art, allowing media utilization to be increased.

Combining the suspension arrangement and the magnetic actuator system disposed in non-coplanar space with the media device allows for high media utilization. For example, on a 10 mm by 10 mm stage, the effective media utilization is expected to be over 80%. Such a high rate of media utilization can allow for high capacity with a small package as compared to prior art probe storage devices as described above.

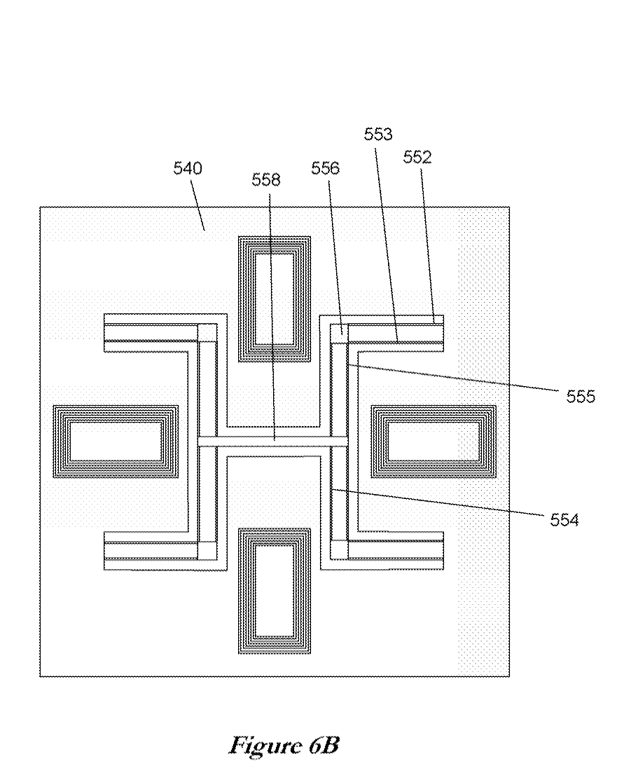

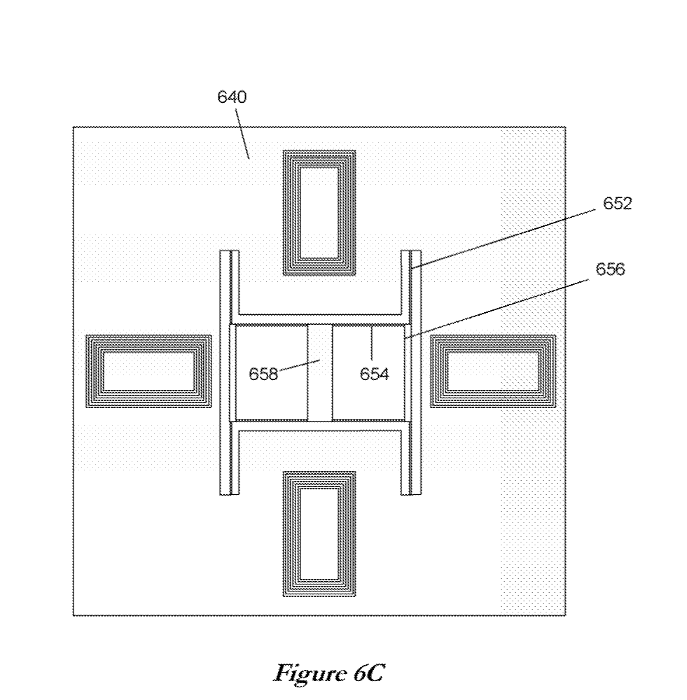

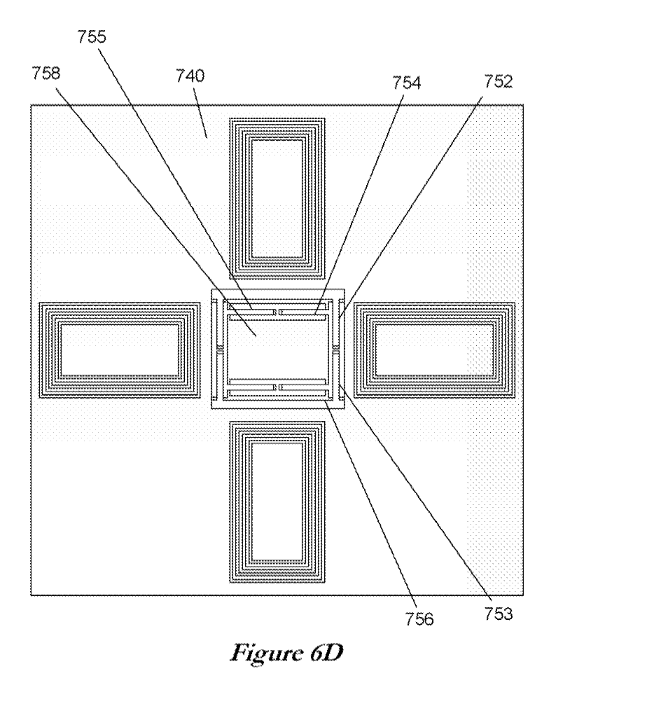

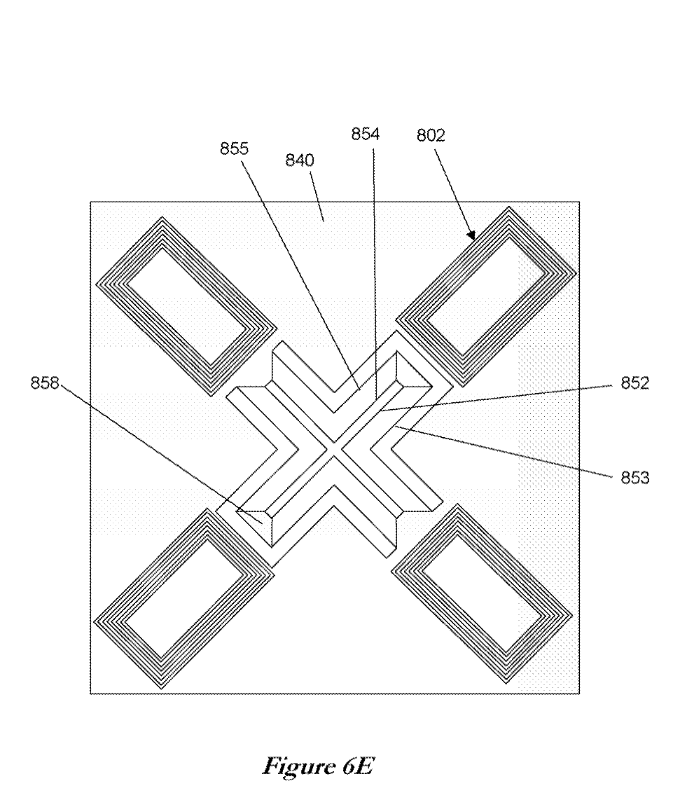

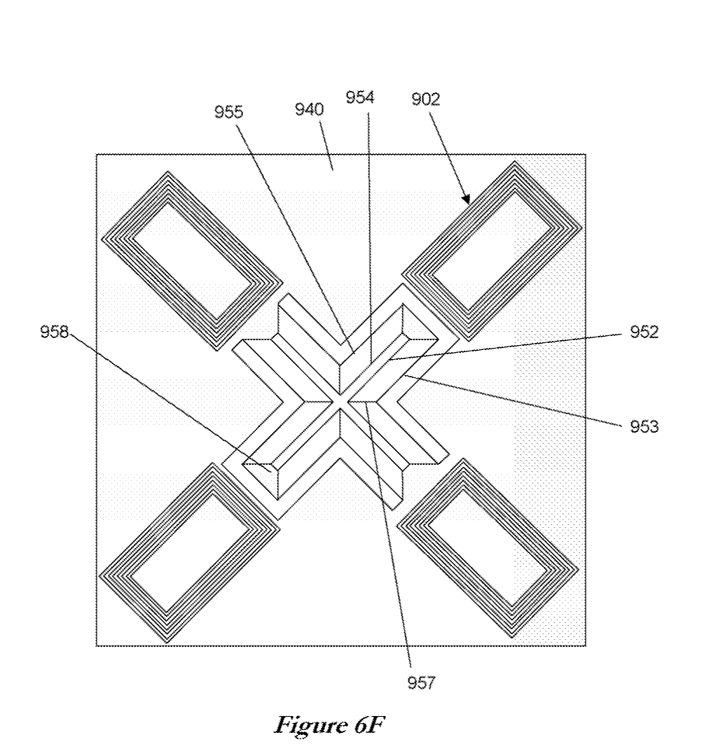

Referring to FIG. 6A, in alternative embodiments a suspension arrangement for a media stage in accordance with the present invention can further include a mass damper 460. The mass damper 460 can include a cantilever 461 extending from the foot 458 between, and in a perpendicular fashion to the two flexures 454,455 connected between the foot 458 and the knee 456. A mass 462 can be connected with the distal end of the cantilever 461. The mass 462 can comprise silicon, or some other material. The length and width of the cantilever 461, and the size of the mass 462 can be adjusted to form a mass damper 460 having a desired resonance frequency. The mass damper 460 resonance frequency can be tuned to correspond to a second resonant frequency of the system to counteract the second resonance frequency. Countering the second resonance frequency can cause energy to be absorbed by the mass damper 460, reducing the severity of a shock response of the suspension arrangement. Alternatively, the mass damper 460 can extend from the knee between the first pair of flexures 452,453 and/or the second pair of flexures 454,455. Alternatively, the mass damper 460 can extend from the platform 440 toward the knee 456 and between the first pair of flexures 452,453 and/or the foot 458 as depicted with respect to the foot 458 in FIG. 6A.

FIGS. 6B and 6C show still more embodiments of suspension arrangements for a media stage in accordance with the present invention, wherein the suspension arrangements support a media stage 540,640 from near a center of the mass of the media stage 540,640. Both suspensions arrangement include a single foot 558,658 positioned near a center of the mass of the media stage 540,640 (or alternatively, multiple foots positioned approximately adjacent to one another), the foot 558,658 being connected with a frame (not shown). FIG. 6B is a plan view of an embodiment wherein mutual pairs of flexures 554,555 extend from a single foot 558, connecting between the single foot 558 and a respective knee 556. A pair of flexures 552,553 extends from the knee 556 toward the direction of the periphery of the media stage 540, connecting to the media stage 540. FIG. 6C is a plan view of an embodiment wherein single flexures 654 extend from the foot 658 and toward the direction of the periphery of the media stage 640, connecting to the media stag 640. The flexure 654 can be linked to a parallel flexure by a single perpendicular flexure 652 having a reinforced portion 656. The suspension arrangement can restrict the positioning of coils on the media stage, and can result in a reduced coil length in one direction (the x-direction as shown). Further, the area occupied by the flexures is increased suspension arrangements such as described in relation to FIG. 3 where flexures are positioned at the periphery of the media stage, reducing the portion of a media die usable for data storage. Still further, such embodiments can have lower rotational stiffness relative to suspension arrangements such as described in relation to FIG. 3.

FIG. 6D is a still further embodiment of a suspension arrangement for a media stage 740 in accordance with the present invention, wherein the suspension arrangements support a media stage 740 from near the center of the mass of the media stage 740. The suspension arrangement includes a foot 758 connected near a center of the mass of the media stage 740, the foot 758 being connected with a frame. A first set of folded flexures 754,755 extend from the foot 758 and connect with parallel support structures 756. A second set of folded flexures 752,753 extend from the parallel support structures 756 and connected with the media stage 740. When the media stage 740 arranged as shown moves in a Y-direction, the first set of folded flexures 754,755 expands and contracts, while when the media stage 740 moves in an X-direction, the second set of folded flexures 752,753 expands and contracts. Such a suspension arrangement can generally provide improved media utilization of many other suspension arrangements. However, such a suspension arrangement can have a low rotational stiffness relative to embodiments described above in reference to FIGS. 3 and 6A-6D.

FIGS. 6E and 6F show still more embodiments of suspension arrangements for a media stage 840,940 in accordance with the present invention, wherein the suspension arrangements support a media stage 840,940 from near the center of the mass of the media stage 840,940. The suspension arrangement includes foots 858,958 connected with a frame (not shown) and arranged at the distal ends of an “X” shaped flexure arrangement. The flexure arrangement includes two sets of flexures 852-855,952-955 connecting the foot 858,958 with the media stage 840,940. In such an embodiments, the coils 802,902 can be arranged diagonally (i.e. at a 45 degree angle relative the coils 302 of FIG. 3) so that the coil length can be increased. Such an arrangement is potentially more efficient because the long length of the coil 802,902 generates more force, thereby reducing the power consumed for the same current. The media stage 840,940 can be urged along the diagonals to position the media relative to the contact probe tip stage (not shown). FIG. 6F is a plan view of an embodiment that further includes support structures 957 connecting two complementary “L-shaped” flexures 952,953 mutually connected to the same feet 958. Such an arrangement has been demonstrated by way of finite element modeling (FEM) to provide a substantial increase in rotational stiffness over the embodiments illustrated in FIG. 6E.

FIGS. 6A-6F are presented and described in detail to broaden an understanding of the invention in general. However, the present invention is not intended to be limited to suspension arrangements and/or media stages as shown in the figures described above, but rather the present invention is meant to include myriad different embodiments employing the underlying principles for arranging a media device as desired relative a contact probe tip. One of ordinary skill in the art will appreciate the myriad different arrangements of flexures for movably connecting a media stage with a stator such as a frame.

It is to be understood that the above described suspension systems can be used with an actuation system that does not use coil and magnet and/or does not rely on the use of Lorentz force. For example, electrostatic actuation systems can be used. Further it is to be understood that alternative suspension systems to those described herein can be used with the coil and magnet and/or Lorentz force actuation system described herein.

It can be desirable to dedicate as large a portion of the media stage as possible to media utilization to increase an amount of capacity of a data storage device for a given footprint (i.e. to increase data storage density). To achieve increased media utilization it can be desired to reduce the percentage of the media stage area dedicated to a support structure and/or suspension arrangement. If a suspension arrangement of the moving stage suspension requires significant area, the total storage capacity of the device will be correspondingly limited. A media stage that is movable is susceptible to damage from dynamic events such as shock and vibration. Embodiments of suspension arrangements and media stages in accordance with the present invention can increase media utilization while improving shock response.

The flatness of a moving stage can vary over a range of operating temperature. For example, if coils comprising copper are disposed on the back side of a media stage comprising silicon, the differential thermal expansion between the silicon stage and the copper coils can cause the stage to bend out of plane, potentially beyond a required flatness tolerance (e.g. 1 μm). To reduce the out of plane bending, a silicon on insulator (SOI) structure is employed having a thermally grown oxide layer buried within a stack forming part of a media stage. The coils are formed over a thin, low temperature chemical vapor deposition (CVD) oxide layer. Subsequently, the wafer is thinned until the thermal oxide layer is exposed. The thermally grown oxide deposited at an elevated temperature will tend to cause the media stage to bend in a first direction such that the surface of the media stage has concave shape. However, since the copper coils are deposited at room temperature on the opposite side of the stack the differential bending caused by the coils causes the media stage to bend in a second, opposite direction. The net result is that the flatness of the media stage remains within tolerances over a desired temperature range.

The foregoing description of the present invention have been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A system for storing data, the system comprising:
a media frame;
a media stage including a media;
a suspension arrangement moveably connecting the media stage with the media frame, the suspension arrangement including a suspension;
wherein the suspension comprises:
a foot fixedly connected with the media frame,
a knee,
a first flexure connected between the foot and the knee so that the knee is moveable relative to the foot, and
a second flexure connected between the media stage and the knee so that the media stage is moveable relative to the knee; and
a tip stage having a tip extending therefrom, the tip stage being arranged so that the media is accessible to the tip.

2. The system of claim 1, wherein the tip stage is connected with the media frame.

3. The system of claim 1, wherein the suspension further comprises a mass damper extending between the foot and the knee.

4. The system of claim 1, wherein:
the suspension arrangement includes four suspensions, and
the suspensions are arranged along a periphery of the media stage.

5. The system of claim 4, wherein the media stage is nested within the media frame.

6. The system of claim 1, wherein:
the suspension arrangement includes a plurality of suspensions, and
the plurality of suspensions have a common foot arranged generally near a center of the media stage.

7. The system of claim 1, further comprising:
a current path operably associated with the media stage; and
a magnet for generating a magnetic field across the current path; and
wherein:
when current is applied to the current path, the media stage is urged in a direction of travel;
the first flexure is arranged one of perpendicular and parallel to the direction of travel; and
the second flexure is arranged the other of perpendicular and parallel to the direction of travel.

8. The system of claim 7, wherein the current path is a coil.

9. A system for storing data, the system comprising:
a media frame;
a media stage including a media;
a current path operably associated with the media stage; and
a magnet for generating a magnetic field across the current path;
wherein when current is applied to the current path, the media stage is urged in a direction of travel;
a suspension arrangement moveably connecting the media stage with the media frame, the suspension arrangement including a suspension;
wherein the suspension comprises:
a foot fixedly connected with the media frame,
a first pair of flexures connected between the foot and the media stage, the first pair of flexures having a foot portion arranged along an x axis of travel and a media stage portion arranged along a y axis of travel perpendicular to the x axis of travel; and
a second pair of flexures connected between the foot and the media stage, the second pair of flexures having a foot portion arranged along the x axis of travel and a media stage portion arranged along the y axis of travel.

10. The system of claim 9, wherein the suspension arrangement includes two suspensions.

11. The system of claim 9, further comprising:
a first brace connected between flexures of the first pair of flexures; and
a second brace connected between the second pair of flexure.

12. The system of claim 9, wherein the suspension further comprises:
a first knee disposed between the foot portion and the media stage portion of the first pair of flexures, and
a second knee disposed between the foot portion and the media stage portion of the second pair of flexures.

13. The system of claim 12, wherein the suspension further comprises a mass damper extending between the foot and the knee.

14. The system of claim 12, wherein:
the suspension arrangement includes four suspensions, and
the suspensions are arranged along a periphery of the media stage.

15. The system of claim 13, wherein the media stage is nested within the media frame.

16. The system of claim 9, further comprising:
a tip stage having a tip extending therefrom, the tip stage being fixedly connected with the media frame; and
wherein the tip stage is arranged so that the media is accessible to the tip.

17. A method of moving a media stage within a media frame, the method comprising:
using a current path operably associated with the media stage and a magnet for generating a magnetic field across the current path;
using a suspension arrangement moveably connecting the media stage with the media frame, the suspension arrangement including a suspension having:
a foot fixedly connected with the media frame,
a knee,
a first flexure connected between the foot and the knee so that the knee is moveable relative to the foot, and
a second flexure connected between the media stage and the knee so that the media stage is moveable relative to the knee; and
urging the media stage is urged in a direction of travel;
allowing the knee to move in the direction of travel;
wherein allowing the knee to move includes allowing one or both of the first flexure and the second flexure to bend.
